(19) United States
(12) Patent Application Publication
(10) Pub. No.: US 2020/0109737 A1
(43) Pub. Date: Apr. 9, 2020

(54) ACCESS PANEL HAVING QUICK RELEASE FASTENERS

(71) Applicant: Sterling Industrial Products, LLC, Lakeland, FL (US)

(72) Inventors: Lydon Dexter Outlaw, Lakeland, FL (US); Christopher Allen Gutierrez, Lakeland, FL (US); Waylon Dale Baker, Plant City, FL (US)

(73) Assignee: Sterling Industrial Products, LLC, Lakeland, FL (US)

(21) Appl. No.: 16/152,109

(22) Filed: Oct. 4, 2018

(51) Int. Cl. F16B 39/24; E06B 5/00

(52) U.S. Cl. CPC F16B 39/24; E06B 5/00

(57) ABSTRACT

Some implementations can include an access panel system comprising an access panel having a plurality of integrated panel lock washers, a plurality of quick release fasteners each having a bolt section, a head section, and a fastener lock washer, and a support ledge configured to support a bottom edge of the access panel.

### TECHNICAL FIELD

Embodiments relate generally to access panels, and more particularly, to access panels having quick release fasteners.

### BACKGROUND

Some conventional access panels may have a plurality of fasteners that require tools to remove. The fasteners on some conventional access panels may also have to be fully removed to remove the panel, which can introduce loose fasteners into a machinery or other operational environment. Removal and replacement of the plurality of fasteners may take considerable time. Further, having loose fasteners present within an operational environment may present a hazard to personnel and/or machinery.

Some implementations were conceived in light of the above, among other things.

### SUMMARY

Some implementations can include an access panel system comprising an access panel having a plurality of integrated panel lock washers, a plurality of quick release fasteners each having a bolt section, a head section, and a fastener lock washer, and a support ledge configured to support a bottom edge of the access panel.

In some implementations, the access panel can include a transparent section. In some implementations, the access panel includes louvers that can be transparent.

In some implementations, the integrated panel lock washers are disposed at respective corners along a top edge of the access panel. In other implementations, the integrated panel lock washers are disposed along a top edge of the access panel.

In some implementations, each of the plurality of quick release fasteners corresponds to one of the integrated panel lock washers. In some implementations, the support ledge includes a horizontal section and a vertical section.

In some implementations, each of the integrated panel lock washers can include a sloped section. In some implementations, each fastener lock washer can include a sloped section.

In some implementations, each integrated panel lock washer can include a sloped section and a panel lock washer detent disposed on the sloped section and configured to mate with a fastener lock washer detent disposed on a sloped section of each fastener lock washer. In some implementations, the bolt section, the head section, and the fastener lock washer are integrated into a single piece.

In some implementations, the head section can include a bolt head. In some implementations, the head section can include one or more fixed wings. In some implementations, the head section can include a hinged wing.

In some implementations, the bolt section can be separate from the head section and the fastener lock washer, which can be integrated into a single piece. In some implementations, the head section and the fastener lock washer can include a threaded interior aperture configured to mate with the bolt section.

In some implementations, the threaded interior aperture can include a threaded nylon sleeve lining the threaded interior aperture. In some implementations, the head section and the fastener lock washer can include an interior aperture configured to permit the bolt section to move through the interior aperture. In Some implementations, the fastener lock washer can further include a beveled portion disposed at an end of the sloped section.

### BRIEF DESCRIPTION OF THE DRAWINGS

FIG. 1 shows an example access panel having quick release fasteners in accordance with some implementations.

FIG. 2 shows detail of the example access panel of FIG. 1 in accordance with some implementations.

FIGS. 3A-3C show details of an example support shelf in accordance with some implementations.

FIG. 4 shows detail of the example access panel in accordance with some implementations.

FIGS. 5 and 6 show an example louvered access panel in accordance with some implementations.

FIGS. 7-10 show an example threaded quick release nut with integrated washer in accordance with some implementations.

FIG. 11 shows an example quick release fastener having a quick release nut and bolt in accordance with some implementations.

FIG. 12 shows detail of an integrated panel locking washer in accordance with some implementations.

FIGS. 13A-13C show an example quick release fastener integrated head and lock washer in accordance with some implementations.

FIGS. 14A-14C show an example quick release fastener integrated head and lock washer with raised hinged wing to permit a tool to engage the head portion in accordance with some implementations.

FIGS. 15A-15D show an example quick release sloped locking washer in accordance with some implementations.

FIGS. 16A-16B show an example quick release sloped locking washer with swivel wing in accordance with some implementations.

FIGS. 17A-17B show example quick release fasteners having an integrated bolt, nut, and sloped lock washer in accordance with some implementations.

FIGS. 18A-18D show an example quick release fastener having a bolt with an integrated sloped lock washer in accordance with some implementations.

### DETAILED DESCRIPTION

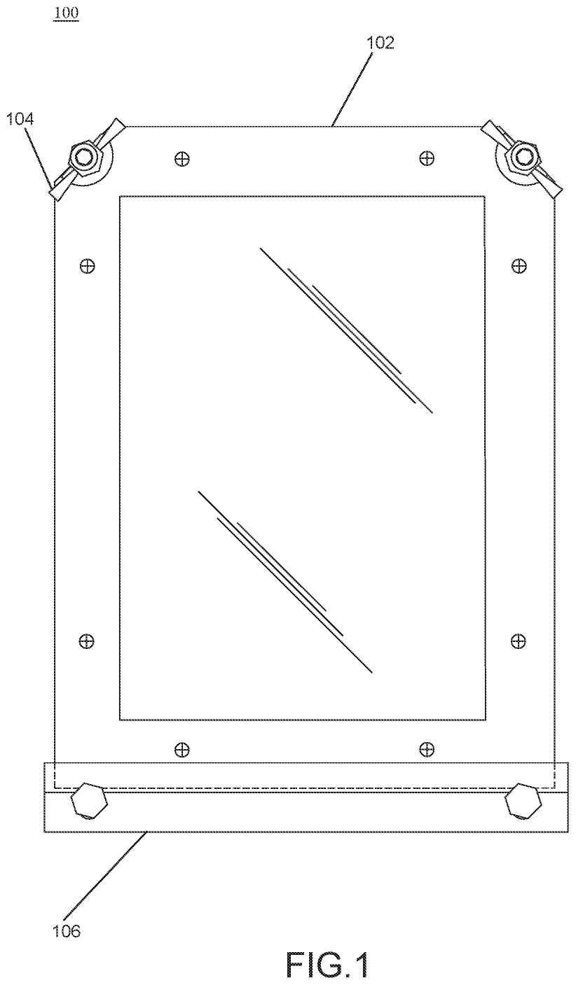

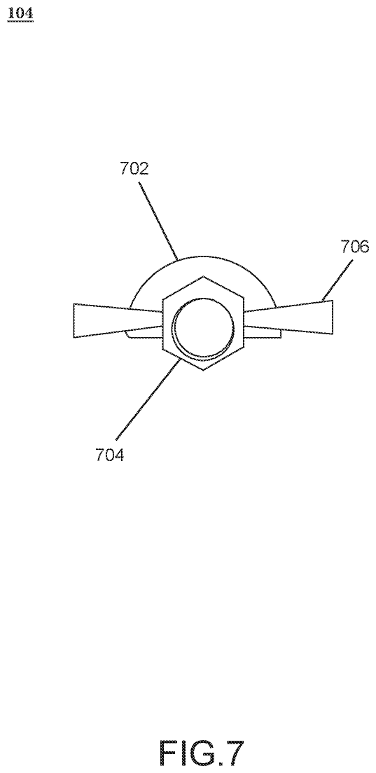

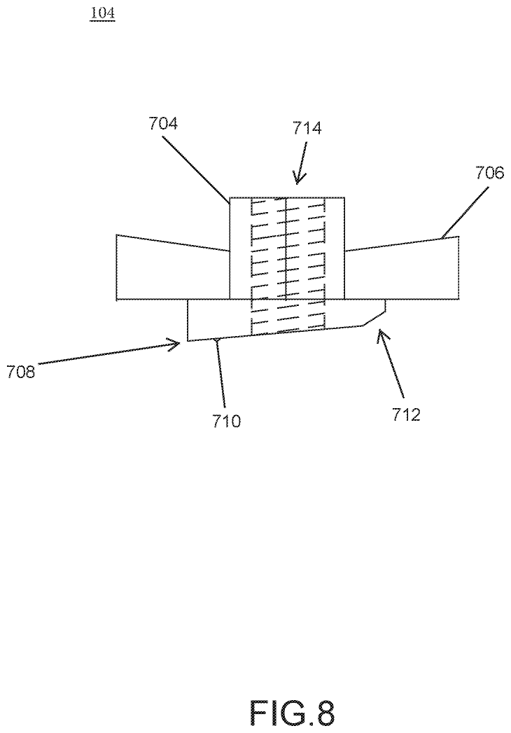

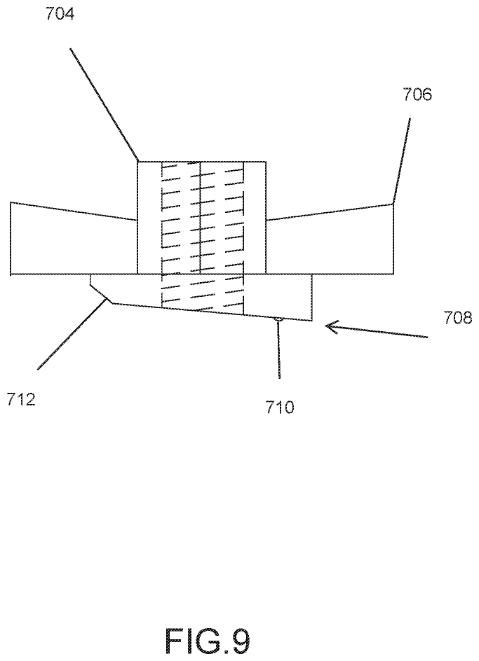

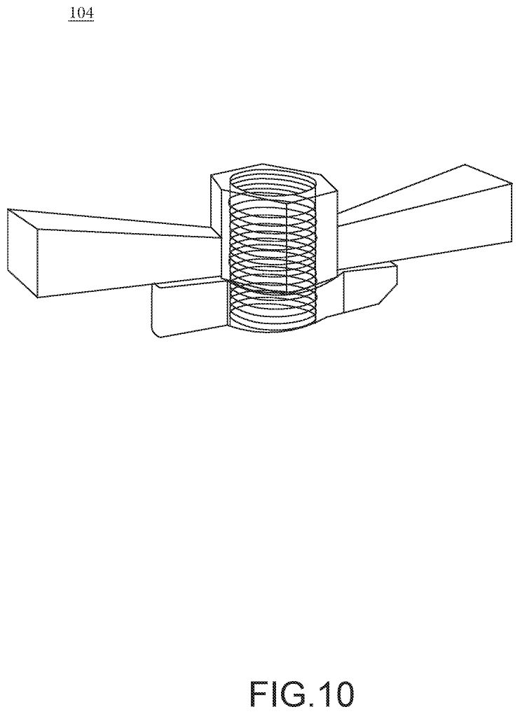

FIG. 1 shows an access panel system 100 for including an access panel 102 having a plurality of integrated panel lock washers (see, e.g., 202 and 204), a plurality of quick release fasteners 104 each having a bolt section, a head section, and a fastener lock washer (see, e.g., FIGS. 7-11 and 13A-18D, and a support ledge (106) configured to support a bottom edge of the access panel 102. The access panel 102 can include a transparent section (as shown in FIG. 1) or can be a solid panel that is opaque. The support ledge 106 can be attached to the object being covered (e.g., machine or other device) via one or more fasteners (e.g., bolts, screws, etc.). The panel system 100 can be configured to be attached to a variety of equipment including machinery, heating ventilation and air condition (HVAC) equipment, pumps, etc. In general, an implementation of the present disclosure can be used with any device where a quick release fastener and/or panel system may be desired. Machinery and machinery environment are non-limiting terms used herein to help illustrate the principles of the disclosed subject matter. It will be appreciated that the quick release fastener and/or panel system can be used with other devices and in other environments.

In operation, the access panel 102 can be removed by turning the quick release fasteners 104 a given amount of rotation ending with the quick release fasteners in a given orientation that places the faster lock washer, which is semi-circular, out of the way of interference for the access panel to pass by the quick release fasteners without the quick release fasteners having to be fully removed from the machine or other object being covered. The access panel 102 can then tilt away from the object being covered past the quick release fasteners and then be simply lifted from the support ledge 106 to remove the panel. Thus, the access panel 102 can be removed by loosening two quick release fasteners 104, which remain attached to the object being covered thereby preventing loose fasteners from being introduced into the area around the object being covered, which can help improve safety for personnel and equipment.

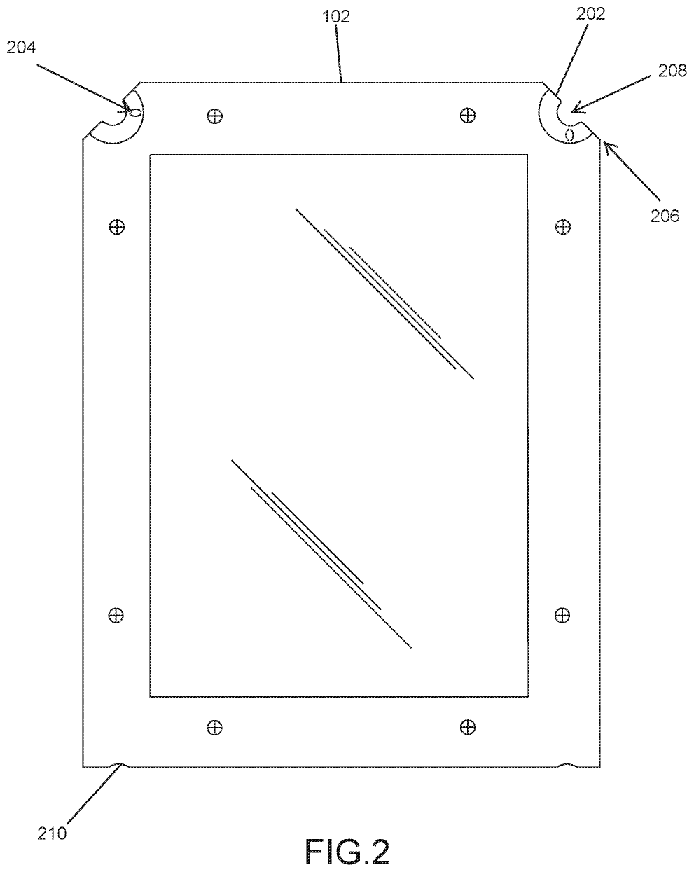

As shown in FIG. 2, the integrated panel lock washers 208 are disposed at respective corners along a top edge of the access panel 102. The integrated lock panel lock washers 208 include a semi-circular lock washer portion 202, a detent 204, and an angled edge 206. The panel 102 can also include one or more bottom edge recesses 210 configured to mate with one or more bolts that attach the support ledge 106 to a piece of equipment that the panel 102 is being attached to. Each of the plurality of quick release fasteners 104 corresponds to one of the integrated panel lock washers 208. Each of the integrated panel lock washers 208 includes a sloped section 202.

Each integrated panel lock washer includes a sloped section 202 and a panel lock washer detent 204 disposed on the sloped section 202 and configured to mate with a fastener lock washer detent (e.g., 710) disposed on a sloped section (e.g., 708) of each fastener lock washer (e.g., 104).

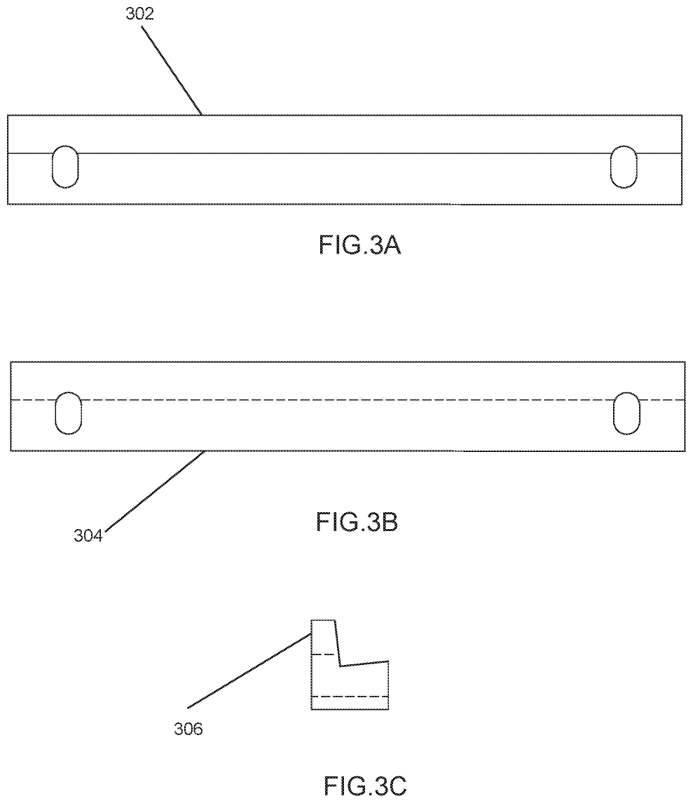

As shown in FIGS. 3A-3C, the support ledge 302 includes a horizontal section 304 and a vertical section 306. In some implementations, an interior vertical surface may not be parallel to an exterior surface of the vertical section 306 and an interior horizontal surface may not be parallel to an exterior horizontal section 304 (as shown in FIG. 3C) to permit the panel to be more easily inserted and removed to/from the support ledge 302.

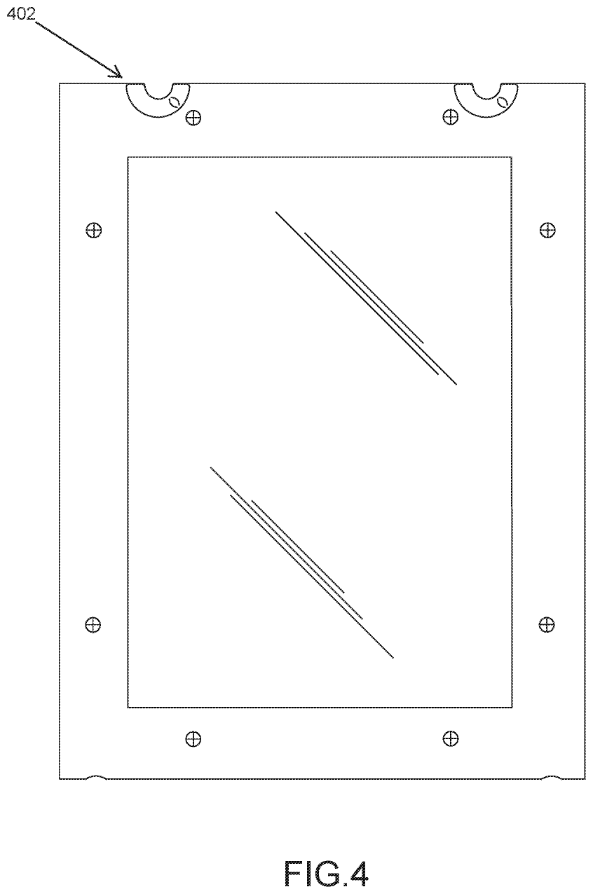

As shown in FIG. 4, some implementations can include integrated panel lock washers disposed along a top edge of the access panel 402.

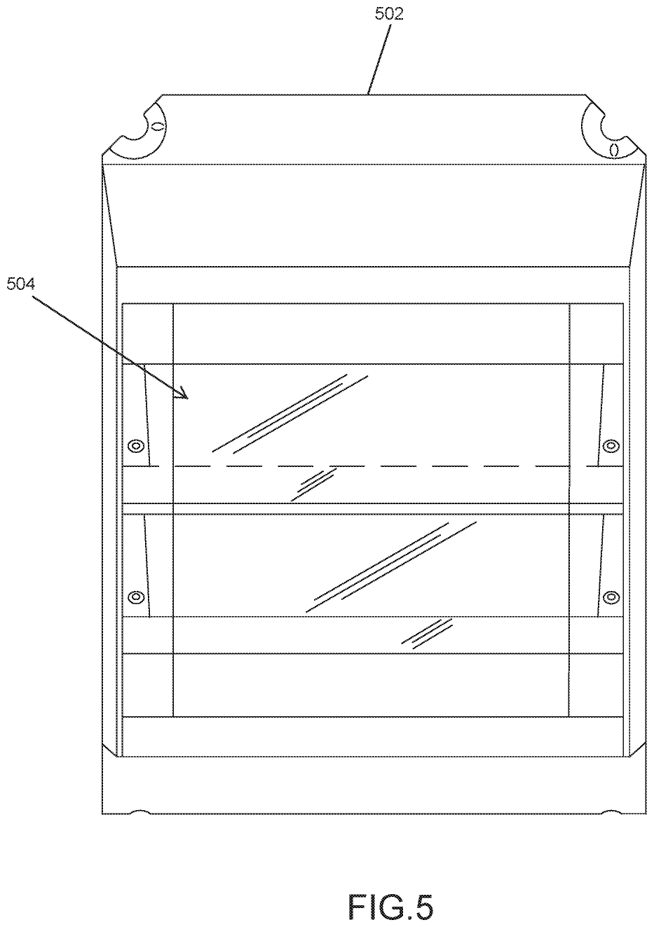

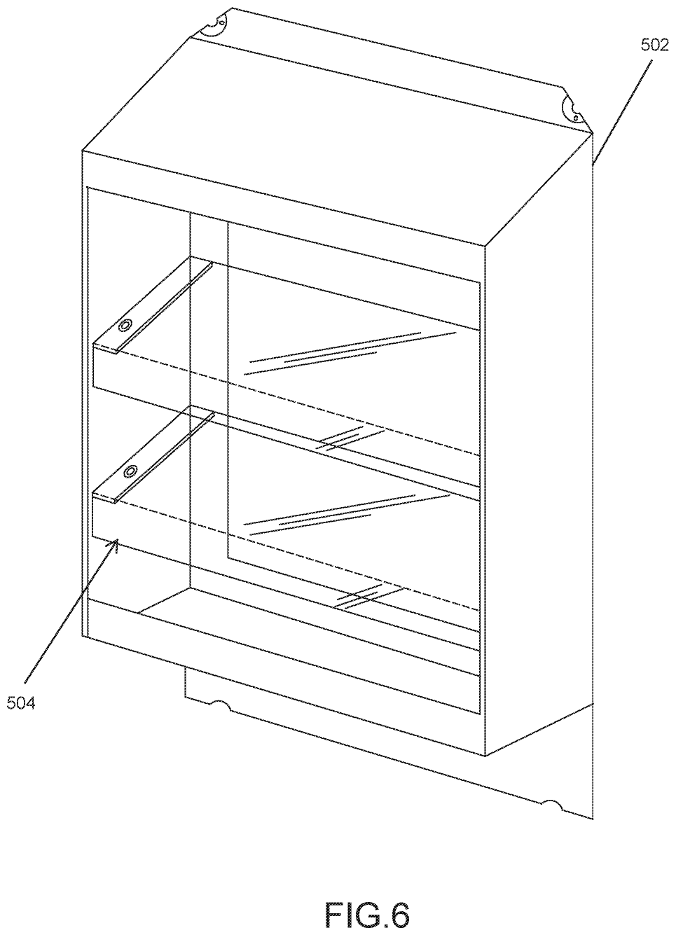

As shown in FIGS. 5 and 6, an access panel 502 can include one or more louvers 504. The louvers 504 can be transparent (as shown in FIGS. 5 and 6) or solid and opaque.

As shown in FIGS. 7-11 a quick release fastener 104 can include a head section 704, a fastener lock washer 702, and a one or more fixed wings 706. The quick release fastener 104 can also include a threaded interior aperture 714 configured to mate with the bolt section 1102. The threaded interior aperture 714 can include a threaded nylon sleeve lining the threaded interior aperture 714. The fastener lock washer further includes a beveled portion 712 disposed at an end of the sloped section 708 and a fastener lock washer detent 710. The head section includes one or more fixed wings (e.g., 706) to permit a user to quickly and easily loosen or tighten the quick release fastener 104 using the user's hands and without requiring tools. The quick release fastener lock washer 708 includes a sloped section configured to increase pressure on the access panel as the quick release fastener is tightened.

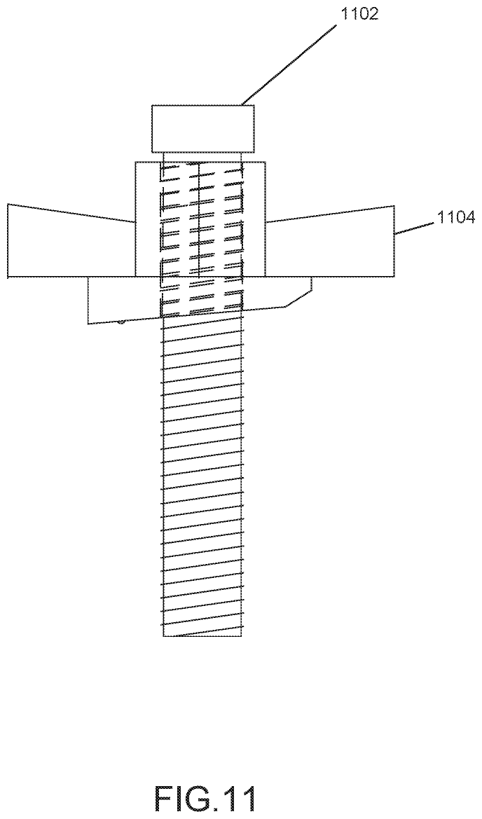

As shown in FIG. 11, the bolt section (e.g., 1102) is separate from the head section and the fastener lock washer, which are integrated into a single piece 104.

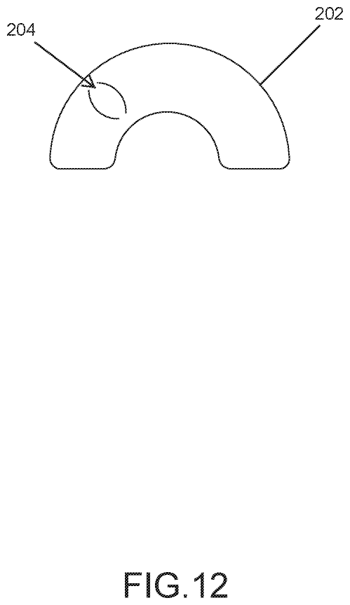

FIG. 12 shows detail of the access panel lock washer 202 and access panel lock washer detent 204 that is configured to mate with the fastener lock washer detent 710 when the faster is turned to the tightened position to help keep the fastener in place and prevent it from becoming loose due to vibration, etc.

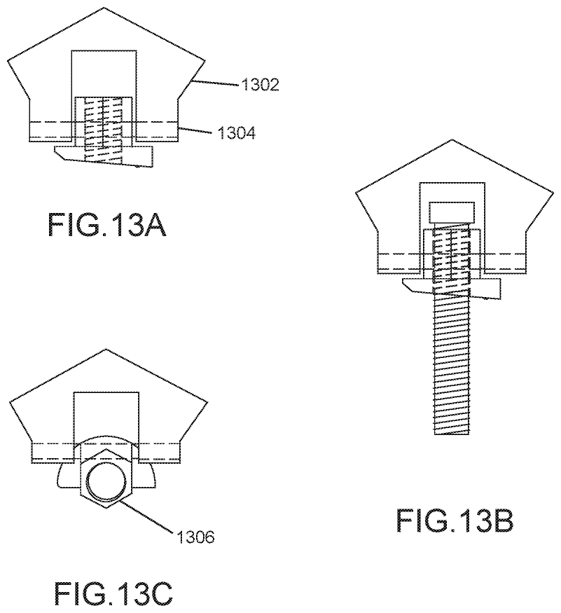

FIGS. 13A-13C show an example quick release fastener integrated head and lock washer in accordance with some implementations. The fastener shown in FIGS. 13A-13C includes a hinged wing 1302 that rotate about a hinge 1304. The hinged wing is used for manual tightening/loosening of the fastener by hand. As shown in FIG. 13C, the hinged wing 1302 can be rotated to a position to permit a tool to engage the head 1306

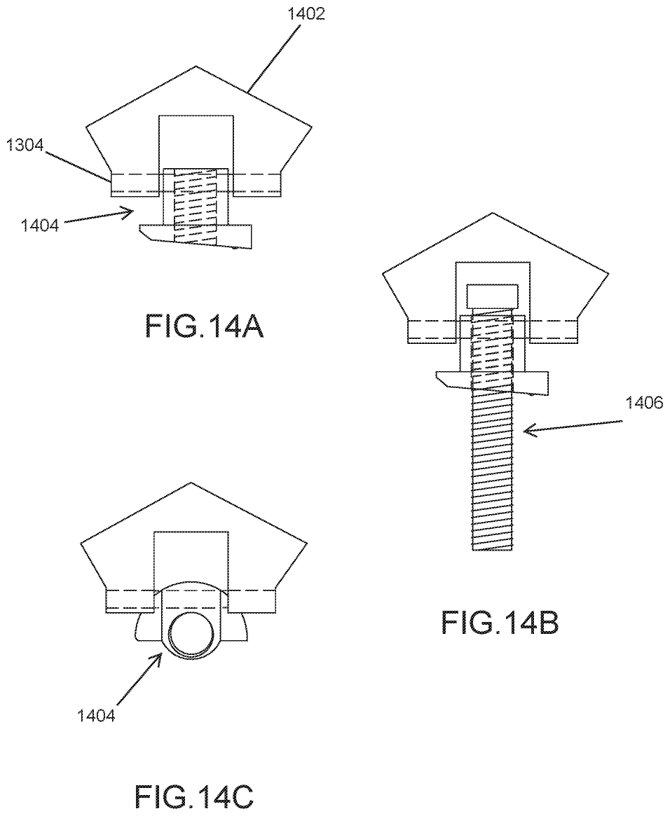

FIGS. 14A-14C show an example quick release fastener integrated head and lock washer with raised hinged wing 1402 to permit a tool to engage the head portion in accordance with some implementations. The raised hinged wing 1402 can rotate about a hinge 1306 similar to hinged wing 1302. However, in the implementation shown in FIGS. 14A-14C, the raised hinged wing 1402 is raised to permit a tool to engage the head at 1404.

For the various implementations having a tool engagement head, the quick release fastener can be tightened/loosened by hand (e.g., via the hinged wing, fixed wing, etc.), by tool via the head engagement (e.g., 1306, 1404, etc.), or by tool via engaging the bolt (e.g., 1406).

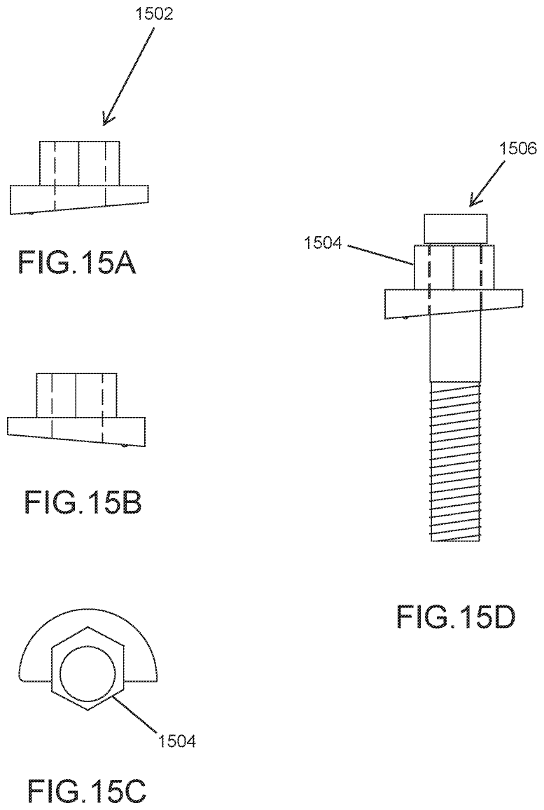

As shown in FIGS. 15A-15D, the head section and the fastener lock washer 1504 include an unthreaded interior aperture 1502 configured to permit the bolt section 1506 to move through the interior aperture.

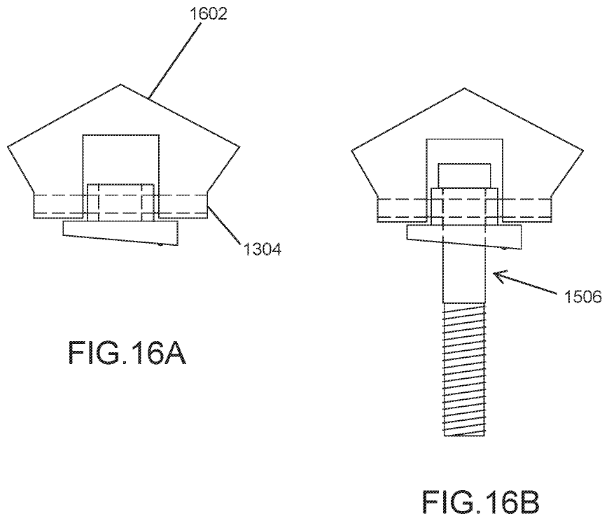

FIGS. 16A-16B show an example quick release sloped locking washer with swivel wing in accordance with some implementations. The quick release sloped locking washer includes a hinged wing 1602 that rotates on a hinge 1304 and can be used to loosen or tighten the pressure between the quick release sloped locking washer and the access panel. The quick release sloped locking washer is held in place by a bolt 1506. The interior aperture of the quick release sloped locking washer implementation shown in FIGS. 16A and 16B is not threaded and is free to move about the bolt 1506.

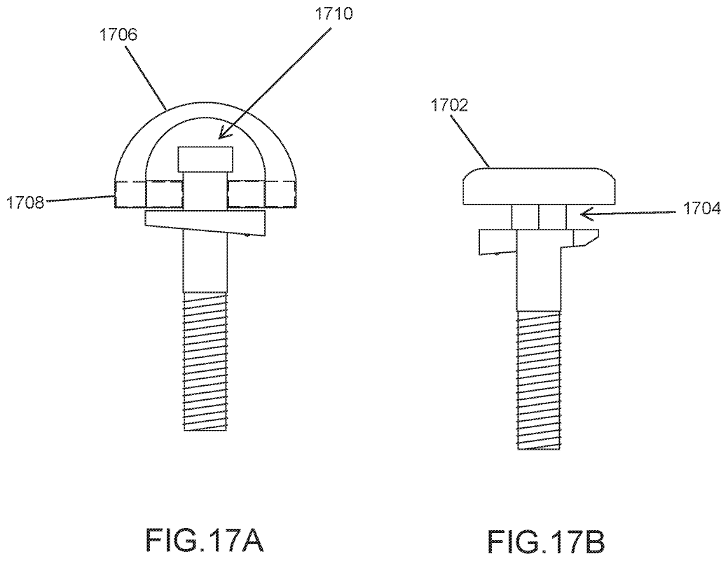

FIGS. 17A-17B show example quick release fasteners having an integrated bolt, nut, and sloped lock washer in accordance with some implementations. FIG. 17A shows an example implementation in which a hinged tightening wing 1706 can rotate about a hinge 1708 to expose the head of a bolt 1710 to be used to initially tighten or loosen the quick release fastener. The hinged wing 1706 can be turned to provide final tightening or initial loosening of the quick release fastener.

FIG. 17B shows an implementation having a hand turned section 1702 that is raised above a bolt head section 1704 to permit operation by hand (e.g., turning 1702) or by tool (e.g., placing an open end wrench around 1704 to turn the quick release fastener. Both implementations (17A and 17B) include a sloped fastener lock washer as described herein.

The head section includes a hinged wing (e.g., 1602 and 1706).

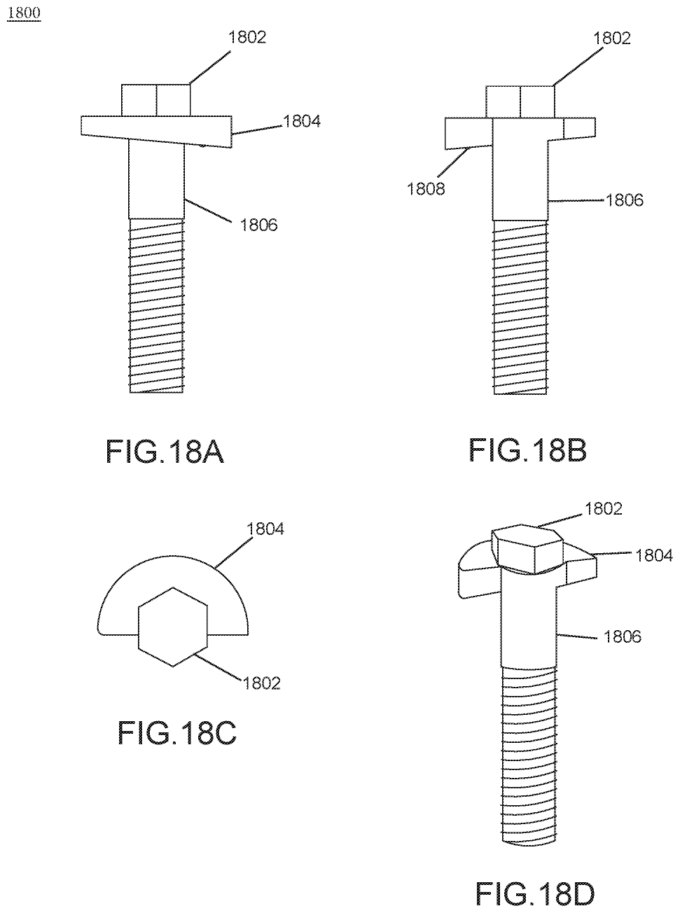

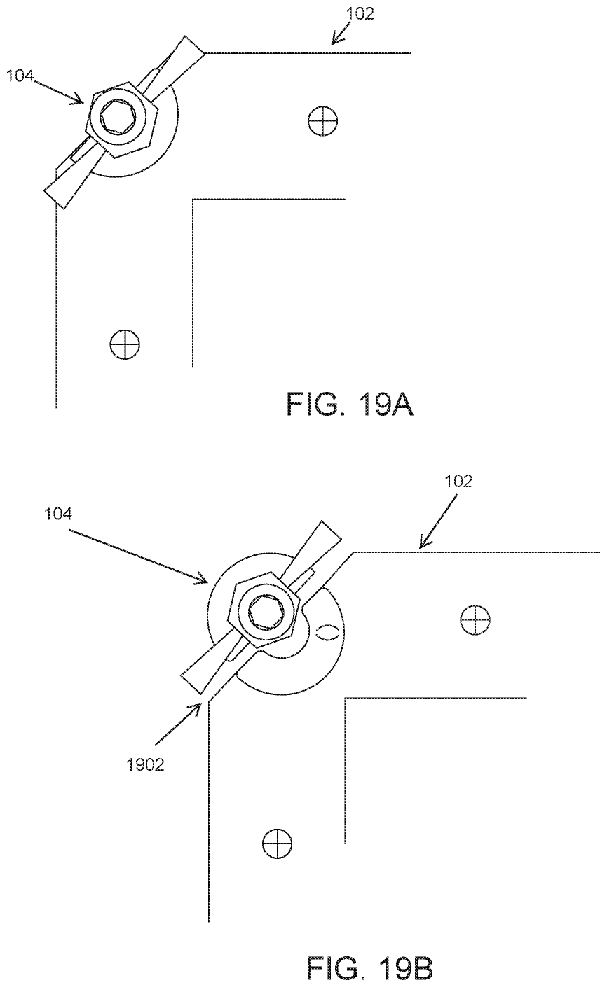

As shown in FIGS. 18A-18D, the bolt section 1806, the head section 1802, and the fastener lock washer 1804 (as described herein, e.g., in conjunction with FIGS. 7-11) are integrated into a single piece 1800. The head section includes a bolt head (e.g., 1802).

In some implementations, the quick release fasteners and/or access panel can be made from metal, plastic, or other suitable material, or a combination of one or more of the above materials.

It is, therefore, apparent that there is provided, in accordance with the various embodiments disclosed herein, access panels having quick release fasteners.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

What is claimed is:

1. An access panel system comprising:
an access panel having a plurality of integrated panel lock washers;
a plurality of quick release fasteners each having a bolt section, a head section, and a fastener lock washer; and
a support ledge configured to support a bottom edge of the access panel.

2. The system of claim 1, wherein the access panel includes a transparent section.

3. The system of claim 1, wherein the access panel includes louvers.

4. The system of claim 3, wherein the louvers are transparent.

5. The system of claim 1, wherein the integrated panel lock washers are disposed at respective corners along a top edge of the access panel.

6. The system of claim 1, wherein the integrated panel lock washers are disposed along a top edge of the access panel.

7. The system of claim 1, wherein each of the plurality of quick release fasteners corresponds to one of the integrated panel lock washers.

8. The system of claim 1, wherein the support ledge includes a horizontal section and a vertical section.

9. The system of claim 1, wherein each of the integrated panel lock washers includes a sloped section.

10. The system of claim 1, wherein each fastener lock washer includes a sloped section.

11. The system of claim 1, wherein each integrated panel lock washer includes a sloped section and a panel lock washer detent disposed on the sloped section and configured to mate with a fastener lock washer detent disposed on a sloped section of each fastener lock washer.

12. The system of claim 1, wherein the bolt section, the head section, and the fastener lock washer are integrated into a single piece.

13. The system of claim 1, wherein the head section includes a bolt head.

14. The system of claim 1, wherein the head section includes one or more fixed wings.

15. The system of claim 1, wherein the head section includes a hinged wing.

16. The system of claim 1, wherein the bolt section is separate from the head section and the fastener lock washer, which are integrated into a single piece.

17. The system of claim 16, wherein the head section and the fastener lock washer include a threaded interior aperture configured to mate with the bolt section.

18. The system of claim 17, wherein the threaded interior aperture includes a threaded nylon sleeve lining the threaded interior aperture.

19. The system of claim 16, wherein the head section and the fastener lock washer include an interior aperture configured to permit the bolt section to move through the interior aperture.

20. The system of claim 10, wherein the fastener lock washer further includes a beveled portion disposed at an end of the sloped section.
